(19) United States
(12) Patent Application Publication
(10) Pub. No.: US 2014/0280282 A1
(43) Pub. Date: Sep. 18, 2014

(54) INTERFACE BETWEEN SPARQL SYSTEMS AND A NON-SPARQL SYSTEM

(71) Applicant: CRAY INC., Seattle, WA (US)

(72) Inventor: David Mizell, Sammamish, WA (US)

(73) Assignee: CRAY INC., SEATTLE, WA (US)

(21) Appl. No.: 13/827,321

(22) Filed: Mar. 14, 2013

(51) Int. Cl. G06F 17/30

(52) U.S. Cl. CPC G06F 17/30427
USPC 707/760

(57) ABSTRACT

A method and system for interfacing SPARQL front ends of SPARQL systems to a non-SPARQL system is provided. A translated SPARQL (“tSPARQL”) system inputs a translated SPARQL query, generates commands for a non-SPARQL system based on the tSPARQL query, and provides those commands to the non-SPARQL system for executing the SPARQL query corresponding to the tSPARQL query. The tSPARQL system translates the tSPARQL query into commands that are provided to a non-SPARQL query engine for executing the SPARQL query represented by the tSPARQL query. When the tSPARQL system receives results of the commands, it provides the results to the SPARQL front end.

### STATEMENT REGARDING FEDERALLY SPONSORED RESEARCH

This invention was made with Government support under Battelle Memorial Institute, Pacific Northwest Division, contract #69356 awarded by the United States Department of Energy. The Government has certain rights in the invention.

### BACKGROUND

Semantic data models allow relationships between resources to be modeled as facts. The facts are often represented as triples that have a subject, a predicate, and an object. For example, one triple may have the subject of “John Smith,” the predicate of “is-a,” and the object of “physician,” which may be represented as

<John Smith, ISA, physician>.

This triple represents the fact that John Smith is a physician. Another triple may be

<John Smith, graduate of, University of Washington>

representing the fact that John Smith graduated from the University of Washington. Yet another triple is

<John Smith, degree, MD>

representing the fact that John Smith has an MD degree. Semantic data models can be used to model the relationships between any type of resource such as web pages, people, companies, products, meetings, and so on. One semantic data model, referred to as the Resource Description Framework (“RDF”), has been developed by the World Wide Web Consortium (“W3C”) to model web resources, but it can be used to model any type of resource. The triples of a semantic data model may be stored in a semantic database that may include a fact table containing the triples representing the facts.

To search for facts of interest, a user may submit a query to a search engine and receive as results the facts that match the query. A query may be specified using the SPARQL language, which is a query language that has been developed for semantic databases that comply with the RDF format. The SPARQL language is defined by a recommendation of the W3C entitled “SPARQL Query Language for RDF.” The acronym “SPARQL” stands for “Simple Protocol and RDF Query Language.” A SPARQL query may include a “select” clause and a “where” clause as shown in the following example:

select ?profession
where {
?x degree ?profession}.

The select clause includes the variable “?profession,” and the where clause includes the query triple with the variable “?x” as the subject, the non-variable “degree” as the predicate, and the variable “?profession” as the object. When a search engine executes this query, it identifies all triples of the database that match the non-variable(s) of the query triple. In this example, the search engine identifies all triples with a predicate of “degree” and returns the objects of those identified triples based on the variable “?profession” being in the select clause and in the object of the query triple of the where clause. For example, the search engine will return “MD” and “JD” when the database contains the following facts:

<John Smith, degree, MD>
<Bill Greene, degree, JD>.

If the select clause had also included the variable “?x,” then the search engine would have returned “John Smith, MD” and “Bill Greene, JD.”

### LL. M.

Many systems, referred to as SPARQL systems, have been developed to process SPARQL queries such as Jena, AllegroGraph, and Virtuoso. Jena is an open source project of the Apache Software Foundation. AllegroGraph and Virtuoso are systems of Franz, Inc. and OpenLink Software, Inc. SPARQL systems include a SPARQL front end and a SPARQL query engine. FIG. 1 is a block diagram that illustrates components of an example SPARQL system. A SPARQL system 100 includes a SPARQL front end 101, a SPARQL query engine 102, and an RDF data store 103. The SPARQL front end provides a user interface for users to create and execute SPARQL queries. When a user wishes to execute a SPARQL query, the SPARQL front end submits the SPARQL query to the SPARQL query engine as a back end. The SPARQL query engine parses the SPARQL query, performs optimizations on the parsed SPARQL query, and then sends commands to the RDF data store for executing the SPARQL query. The SPARQL query engine receives triples from the RDF data store, compiles the triples into the results, and forwards the results to the SPARQL front end to be presented to the user.

Each SPARQL system provides a specialized user interface for developing SPARQL queries. Developers of SPARQL systems design their front ends to provide sophisticated tools for both developing SPARQL queries and displaying the results of SPARQL queries. A user of a SPARQL system may find that over time the SPARQL query engine and RDF data store cannot meet their changing needs. For example, a user may need to store increasingly larger amounts of information in the RDF data store and may need to perform increasingly more sophisticated analyses on the data. The user's SPARQL system, however, may neither have the data storage capacity or the computational power to support the user's changing needs. Although the SPARQL system may not meet a user's needs in terms of storage capacity and computational power, the user may well like to continue using the SPARQL front end with the sophisticated tools that the user has grown accustomed to.

To meet their changing needs, users may want to replace their existing query engine and RDF data store with a more powerful system. These more powerful systems, however, may provide a query engine that is not compatible with the user's SPARQL front end and may not even be designed to handle SPARQL queries. The interfaces between the SPARQL query engines and their corresponding SPARQL front ends typically use very different protocol. Thus, one SPARQL query engine could not be substituted for another. Similarly, the interfaces between the SPARQL query engines and their RDF data stores may also use very different protocols and one RDF data store could not be substituted for another. FIG. 2 is a block diagram that illustrates one approach for allowing the use of a SPARQL front end with a powerful non-SPARQL query engine. A SPARQL front end 211 and a SPARQL query engine 212 are components of one SPARQL system, and a SPARQL front end 221 and a SPARQL query engine 222 are components of another SPARQL system. Since the interfaces between the SPARQL query engines and their RDF data stores are not compatible with each other, mappers 213 and 223 need to be developed to map their commands to the commands of non-SPARQL query engine 250 and its RDF data store 260. The mappers also need to be able to translate the results of the non-SPARQL query engine to the format expected by the corresponding SPARQL query engine. Mappers could also be developed to interface a SPARQL front end with the non-SPARQL query engine without using the SPARQL query engine.

A developer of non-SPARQL system with enhanced storage capacity and computational power may want to offer the system to current users of SPARQL systems. However, the developer of the non-SPARQL system would need to provide a mapper for each SPARQL system to be supported. Moreover, as new versions of the SPARQL systems are released, the developer would need to upgrade the various mappers based on changes in the SPARQL systems. The development of such mappers and the continual upgrading of the mappers can be both expensive and time-consuming and limit the potential market for the non-SPARQL system.

It would be desirable if a non-SPARQL system could interface with SPARQL front ends without needing a separate mapper for each SPARQL system and without having to upgrade the mappers as new versions of the SPARQL systems are released.

### BRIEF DESCRIPTION OF THE DRAWINGS

FIG. 1 is a block diagram that illustrates components of an example SPARQL system.

FIG. 2 is a block diagram that illustrates one approach for allowing the use of a SPARQL front end with a powerful non-SPARQL query engine.

FIG. 3 is a block diagram that illustrates a tSPARQL processor interfacing with various SPARQL systems.

### DETAILED DESCRIPTION

A method and system for interfacing SPARQL front ends of SPARQL systems to a non-SPARQL system is provided. In some embodiments, a parsed SPARQL system inputs a translated SPARQL query, generates commands for a non-SPARQL system based on the translated SPARQL query, and provides those commands to the non-SPARQL system for executing the SPARQL query corresponding to the translated SPARQL query (“tSPARQL”). When executing a SPARQL query, SPARQL query engines generate a translated SPARQL query corresponding to that SPARQL query. A tSPARQL query is in a form that facilitates the optimization of the execution of the SPARQL query by the SPARQL query engine. SPARQL query engines typically include an option for outputting the tSPARQL, which can be used by developers of the SPARQL query engines or users of a SPARQL system for debugging purposes. For example, Jena includes the ARQ query engine with an “arq.qparse” command line application through which a tSPARQL representation of a SPARQL query can be output. The tSPARQL queries conform to a standard syntax as defined by the SPARQL query. The tSPARQL system provides a tSPARQL processor that inputs a tSPARQL query and translates the tSPARQL query into commands that are provided to a non-SPARQL query engine for executing the SPARQL query represented by the tSPARQL query. When the tSPARQL processor receives the results of the commands, it provides the results to the SPARQL front end. In this way, the tSPARQL system allows a non-SPARQL system with a non-SPARQL query engine to execute SPARQL queries developed with a SPARQL system.

Table 1 provides an example SPARQL query, and Table 2 provides the corresponding tSPARQL query.

TABLE 1

| | |
|---|---|
| 1. | SELECT ?x (SUM(?val) AS ?totalReceived) |
| 2. | WHERE { ?y <urn:noblis.org/bitcoin#pays> ?x. |
| 3. | ?y <urn:noblis.org/bitcoin#hasvalue> ?val} |
| 4. | GROUP BY ?x |
| 5. | ORDER BY DESC(?totalReceived) |

TABLE 2

| | |
|---|---|
| 1. | (project (?x ?totalReceived) |
| 2. | (order ((desc ?totalReceived)) |
| 3. | (extend ((?totalReceived ?.0)) |
| 4. | (group (?x) ((?.0 (sum ?val))) |
| 5. | (quadpattern |
| 6. | (quad <urn:x-arq:DefaultGraphNode> ?y <urn:noblis.org/ |
| | bitcoin#pays> ?x) |
| 7. | (quad <urn:x-arq:DefaultGraphNode> ?y <urn:noblis.org/ |
| | bitcoin#hasvalue>?val) |
| 8. | )))) |

FIG. 3 is a block diagram that illustrates a tSPARQL processor interfacing with various SPARQL systems. A tSPARQL processor 300 receives tSPARQL queries that are output by various SPARQL query engines 212 and 222. The tSPARQL processor translates the tSPARQL query into commands for the non-SPARQL query engine 250, which accesses RDF data store 260. When the non-SPARQL query engine receives the results, it provides them to the appropriate SPARQL front end 211 and 221. Although the tSPARQL processor is shown as connected to two different SPARQL systems, the tSPARQL processor would typically only be connected to one SPARQL system. By enabling the option of SPARQL systems to output the tSPARQL representation of a SPARQL query, the tSPARQL system allows any non-SPARQL system or more generally any database system to serve as a query engine and data store (i.e., back end) for any SPARQL system. When a new version of a SPARQL system is released, the tSPARQL system would not need to be modified. If the definition of the syntax for the tSPARQL queries as defined by the W3C recommendations were to change, the tSPARQL processor could be modified to accommodate the change and be able to process tSPARQL queries with the changed syntax generated by any SPARQL system. The tSPARQL processor is a computer program that uses conventional techniques to translate a tSPARQL query into commands for the non-SPARQL system and may include a parser for parsing a tSPARQL query as part of the translation process. The command generated by the tSPARQL processor may be implemented as an invocation of a function of an application programming interface (“API”) provided by the non-SPARQL query engine.

The tSPARQL system, the SPARQL systems, and the non-SPARQL system may be implemented on computing systems that include a central processing unit and local memory and may include input devices (e.g., keyboard and pointing devices), output devices (e.g., display devices), and storage devices (e.g., disk drives). The central processing units may access computer-readable media that include computer-readable storage media and data transmission media. The computer-readable storage media include memory and other storage devices that may have recorded upon or may be encoded with computer-executable instructions or logic that implements the systems. The data transmission media is media for transmitting data using signals or carrier waves (e.g., electromagnetism) via a wire or wireless connection. The computing systems may comprise multiple nodes connected via a network interconnect. The nodes may be designated as compute nodes and service nodes. The SPARQL front ends and the SPARQL query engines may execute on service nodes, and the non-SPARQL system may execute on compute nodes. The tSPARQL system may execute on either service nodes or compute nodes. A non-SPARQL query engine and the RDF data store may be implemented on a computing system that is based on the Cray XMT architecture.

Although the subject matter has been described in language specific to structural features and/or acts, it is to be understood that the subject matter defined in the appended claims is not necessarily limited to the specific features or acts described above. Rather, the specific features and acts described above are disclosed as example forms of implementing the claims. Accordingly, the invention is not limited except as by the appended claims.

I/We claim:

1. A computing system for executing SPARQL queries generated by SPARQL systems, the SPARQL systems having a SPARQL front end and a SPARQL query engine, the computing system comprising:
an RDF data store;
a non-SPARQL query engine that
receives commands in a format specific to the non-SPARQL query engine, the commands for accessing the RDF data store;
performs instructions for accessing the RDF data store in accordance with the commands; and
provides results of accessing the RDF data store; and
a translated SPARQL processor that
receives from the SPARQL query engine a translated SPARQL query representation of a SPARQL query;
process the translated SPARQL representation query to generate commands in a format specific to the non-SPARQL query engine, the commands for directing the non-SPARQL query engine to access the RDF data store for execution of the SPARQL query;
sends the generated commands to the non-SPARQL query engine;
receives results of the generated commands; and
provides the results to the SPARQL front end.

2. The computing system of claim 1 wherein each SPARQL query engine provides a command to output a translated SPARQL representation of a SPARQL query.

3. The computing system of claim 1 wherein each SPARQL query engine is designed to interface with a specific data store using commands specific to that data store.

4. The computing system of claim 3 wherein the commands of one data store are incompatible with the commands of another data store.

5. The computing system of claim 1 wherein the parsed SPARQL processor includes a parser for parsing the translated SPARQL query representation.

6. The computing of claim 1 wherein the parsed SPARQL processor is adapted to interface with different SPARQL query engines that generate translated SPARQL queries.

7. A computer-readable storage medium containing computer-executable instructions for controlling execution of a SPARQL query, the instructions comprising:
a component that receives from a SPARQL query engine of a SPARQL system a translated SPARQL query representation a SPARQL query;
a component that parses the translated SPARQL query representation and generates commands for a non-SPARQL query engine, the commands for directing the non-SPARQL query engine to access the RDF data store to perform processing for execution of the SPARQL query;
a component that sends the generated commands to the non-SPARQL query engine for execution of the SPARQL query;
a component that receives the results of accessing the RDF data store; and
a component that provides the results to a SPARQL front end of the SPARQL system.

8. The computer-readable storage medium of claim 7 wherein the SPARQL query engine provides a command for outputting a translated SPARQL query representation of a SPARQL query.

9. The computer-readable storage medium of claim 7 wherein the SPARQL query engine is designed to interface with a specific data store using commands specific to that data store.

10. The computer-readable storage medium of claim 9 wherein the commands of one data store are incompatible with the commands of another data store.

11. The computer-readable storage medium of claim 7 wherein the component that generates the commands includes a parser for parsing the translated SPARQL query representation.

12. The computer-readable storage medium of claim 7 wherein the parsed SPARQL processor is adapted to interface with different SPARQL query engines that generate translated SPARQL queries.

13. A method performed by a computing device to support execution of a SPARQL query, comprising:
receiving from a SPARQL query engine a translated SPARQL query, the translated SPARQL query representing a SPARQL query
generating from the translated SPARQL query commands to execute the SPARQL query, the commands for directing a non-SPARQL query engine to access an RDF data store for execution of the SPARQL query, the non-SPARQL query engine not adapted to input a SPARQL query; and
providing the commands to the non-SPARQL query engine to perform processing of the SPARQL query.

14. The method of claim 13 including receiving results of the commands from the non-SPARQL query engine and providing the results to a SPARQL front end that submitted the SPARQL query to the SPARQL query engine.

15. The method of claim 14 including receiving from a second SPARQL query engine a second translated SPARQL query, generating second commands to execute the second translated SPARQL query, and providing the second commands to the non-SPARQL query engine.

16. The method of claim 14 wherein the SPARQL query engine includes an option to generate a translated SPARQL query representation of a SPARQL query.
